(19) United States
(12) Patent Application Publication
(10) Pub. No.: US 2026/0141837 A1
(43) Pub. Date: May 21, 2026

(54) DISPLAY DRIVING DEVICE

(71) Applicant: MagnaChip Semiconductor, Ltd., Cheongju-si (KR)

(72) Inventors: Hongju KIM, Seoul (KR); Youngshin KIM, Gimpo-si (KR); Jaewon KIM, Seoul (KR); Hyein KIM, Guri-si (KR); Seungjo SHIN, Suwon-si (KR)

(73) Assignee: MagnaChip Semiconductor, Ltd., Cheongju-si (KR)

(21) Appl. No.: 19/242,191

(22) Filed: Jun. 18, 2025

(30) Foreign Application Priority Data
Nov. 19, 2024 (KR) 10-2024-0165443

(51) Int. Cl. G09G 3/20

(52) U.S. Cl. CPC G09G 3/2092; G09G 2310/0272; G09G 2310/0291; G09G 2330/021; G09G 2330/045

(57) ABSTRACT

A display drive device configured to drive a display panel includes a timing controller configured to compare current data to previous data based on a channel unit in horizontal time, calculate data difference values, and output a bias control signal determined based on a maximum value among the calculated data difference values; and a source driver configured to generate a bias current based on the bias control signal and based on the channel unit. The source driver includes an output circuit configured to output a data signal to a plurality of channels based on the bias current generated based on the channel unit.

### CROSS REFERENCE TO RELATED APPLICATION

The present application claims the benefit under 35 U.S.C. § 119 (a) of Korea Patent Application No. 10-2024-0165443, filed on Nov. 19, 2024, in the Korean Intellectual Property Office, the entire disclosure of which is incorporated herein by reference for all purposes.

### BACKGROUND

### 1. Field

The present disclosures relates to a display drive device capable of regulating a slew rate of data signals output from a source driver and improving consumption of a current.

### 2. Discussion of Related Art

The display device may include a display panel and a display drive device configured to control the display panel. The display drive device may transmit data signals to the display panel.

In the case of a display panel which includes a plurality of pixels, a driver circuit is connected to the pixels arranged in a matrix form through source lines (data lines) and gate lines (scan lines). The driver circuit connected to each source line is called a source driver, and the driver circuit connected to each gate line is called a gate driver. Among them, the source driver includes a source amplifier configured to output a drive signal to drive a pixel circuit of the display panel. The source amplifier generally maintains a relatively high slew rate to ensure stable transition of the output within a specified time (several microseconds). This increases the power consumption of the source amplifier and heats up the driver IC.

Therefore, to solve the problems described above, various examples of the present disclosure aim to provide a display drive device that improves the heating characteristics by adjusting the slew rate, reducing the power consumption, and changing the magnitude of the bias current supplied to the source amplifier.

The technical problem to be solved by the present disclosure is not limited to the above-mentioned technical problem, but also includes other technical problems that can be clearly understood by a person skilled in the technical field related to the present disclosure from the following description.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a display drive device configured to drive a display panel includes a timing controller configured to compare current data to previous data based on a channel unit in horizontal time, calculate data difference values, and output a bias control signal determined based on a maximum value among the calculated data difference values; and a source driver configured to generate a bias current based on the bias control signal and based on the channel unit The source driver may include an output circuit configured to output a data signal to a plurality of channels based on the bias current generated based on the channel unit.

The timing controller may include a slew rate bias operation circuit configured to divide the data difference values into intervals based on the channel unit of the source driver and set a plurality of threshold intervals, and output the bias control signal matched with the plurality of threshold intervals including the maximum value.

The slew rate bias operation circuit may be configured to set a bias control signal such that the bias current having a greater magnitude is generated when the maximum value is included in a higher threshold interval among the plurality of threshold intervals.

The slew rate bias operation circuit may include: a data buffer storing the previous data; a data comparator configured to calculate a data difference value by comparing the current data to the previous data stored in the data buffer based on the channel unit; and a bias control signal generator configured to select a threshold interval including the maximum value among the plurality of threshold intervals, and generate a bias control signal matched with the selected threshold interval based on the channel unit.

The source driver may further include: an input circuit configured to divide image data input based on the channel unit into image data based on the channel unit of the source driver and output the image data; a conversion circuit configured to output analogue voltages corresponding to the image data divided based on the channel unit; and a slew rate control circuit configured to generate the bias current to regulate a slew rate of the source driver based on the bias control signal.

The output circuit may include a plurality of source amplifiers provided in each channel of the source driver and configured to output the data signal based on a magnitude of the bias current.

The timing controller may be configured to output a normal bias control signal or an active bias control signal based on a bias control operation activating signal, the normal bias control signal may be a signal that controls the source driver to use a bias current having a maximum magnitude, and the active bias control signal may be a signal that controls the source driver to use a bias current having a value less than or equal to the maximum magnitude.

The timing controller may be configured to output the normal bias control signal only when the bias control operation activating signal is an off signal, and the timing controller may be configured to output the normal bias control signal at a porch interval of a frame and output the active bias control signal at an active interval except the porch interval when the bias control operation activating signal is an on signal.

In another general aspect, a method for operating a display drive device configured to drive a display panel, the method including: generating image data to be displayed on a display panel; allowing a timing controller to compare current data to previous data based on a channel unit of a source driver in horizontal time and calculate data difference values; obtaining a maximum value among the calculated data difference values; outputting a bias control signal based on the maximum value; and outputting a bias current to be provided to an output circuit of the source driver according to the bias control signal.

The obtaining of the maximum value among the calculated data difference values may further include: dividing the data difference values into intervals based on the obtained maximum value, and setting a plurality of threshold intervals; and setting a magnitude of the bias current corresponding to each of the plurality of threshold intervals.

The setting of the magnitude of the bias current corresponding to each of the plurality of threshold intervals may further include: setting the magnitude of the bias current to be greater when the maximum value is high in each of the plurality of threshold intervals.

The outputting of the bias current to be provided to the output circuit of the source driver according to the bias control signal may further include: outputting a data signal to the display panel based on a magnitude of the bias current generated based on the channel unit.

In another general aspect, a display drive device configured to drive a display panel, including: a timing controller configured to: compare current data to previous data based on a normal bias control signal or based on a channel unit, calculate data difference values, and output an active bias control signal determined based on a maximum value among the calculated data difference values; and a slew rate control circuit configured to receive the normal bias control signal or the active bias control signal and control an output circuit of a source driver.

The timing controller may include: a slew rate bias operation circuit configured to: divide the data difference values into intervals based on the channel unit of the source driver, and set a plurality of threshold intervals and output a bias control signal matched with the plurality of threshold intervals including the maximum value.

The slew rate bias operation circuit may be configured to set the active bias control signal such that a bias current having a greater magnitude is generated when the maximum value is included in a higher threshold interval among the plurality of threshold intervals.

The slew rate bias operation circuit may include: a data buffer storing the previous data; a data comparator configured to compare the current data to the previous data stored in the data buffer based on the channel unit to calculate a data difference value; and a bias control signal generator configured to select a threshold interval including the maximum value among the plurality of threshold intervals and generate the bias control signal matched with the selected threshold interval based on the channel unit.

The source driver may include: an input circuit configured to divide image data input based on the channel unit into image data based on the channel unit of the source driver and output the image data; a conversion circuit configured to output analogue voltages corresponding to the image data divided based on the channel unit; and an output circuit configured to output a data signal to the display panel based on the analogue voltages and a bias current.

The output circuit may include: a plurality of source amplifiers provided in each channel of the source driver and configured to output the data signal based on a magnitude of the bias current.

The timing controller may be configured to output the normal bias control signal or the active bias control signal based on a bias control operation activating signal. The normal bias control signal may be a signal that controls the source driver to use a bias current having a maximum magnitude, and the active bias control signal may be a signal that controls the source driver to use a bias current having a value less than or equal to the maximum magnitude.

The timing controller may be configured to output the normal bias control signal only when the bias control operation activating signal is an off signal. The timing controller may be configured to output the normal bias control signal at a porch interval of a frame and output the active bias control signal at an active interval except the porch interval when the bias control operation activating signal is an on signal.

According to an example of the present disclosure, it is possible to provide a display drive device which improves the heating characteristics by regulating a slew rate and reducing power consumption through variation of a magnitude of the bias current provided to the source amplifier per channel.

Effects which may be obtained by the present disclosure are not limited to the aforementioned effects, and other technical effects not described above may be evidently understood by a person having ordinary skill in the art to which the present disclosure pertains from the following description.

Other features and aspects will be apparent from the following detailed description, the drawings, and the claims.

### BRIEF DESCRIPTION OF THE DRAWINGS

FIG. 1 illustrates a display device according to an example of the present disclosure.

FIG. 2 illustrates a slew rate bias operation circuit according to an example of the present disclosure.

FIG. 3 illustrates a timing diagram for describing an operation of a slew rate bias operation circuit according to an example of the present disclosure.

FIG. 4 illustrates a timing diagram for describing an operation of a timing controller according to an example of the present disclosure.

FIG. 5 illustrates a source driver according to an example of the present disclosure.

FIG. 6 illustrates an operation method of a display drive device according to an example of the present disclosure.

FIG. 7 illustrates a method for determining a magnitude of a bias current according to an example of the present disclosure.

FIG. 8 illustrates a method for generating a data signal in a source driver and outputting the data signal to a display panel according to an example of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The merits and characteristics of the present disclosure and a method for achieving the merits and characteristics will become more apparent from the embodiments described in detail in conjunction with the accompanying drawings. However, the present disclosure is not limited to the disclosed embodiments, but may be implemented in various different ways. These embodiments are provided so that this disclosure will be thorough and complete, and will fully convey the scope of the present disclosure to those skilled in the art. The present disclosure will be defined only by the scope of the appended claims. Like reference numerals generally denote like elements throughout the specification.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items.

The terms used in the present specification are merely used to describe specific embodiments and are not intended to limit the present disclosure. A singular expression includes a plural expression unless a description to the contrary is specifically pointed out in context. The terms “comprises” and/or “comprising,” when used herein, specify the presence of stated elements, steps, operations, and/or components, but do not preclude the presence or addition of one or more other elements, steps, operations, and/or components.

Although the terms including an ordinal number such as first, second, etc. may be used for describing various elements, the structural elements are not restricted by the terms. The terms are only used to distinguish one element from another element.

Therefore, a first component to be mentioned below may be a second component in a technical concept of the present disclosure. Unless otherwise defined, all terms including technical and scientific terms used herein have the same meaning as commonly understood by one of ordinary skill in the art to which this disclosure belongs. It will be further understood that terms, such as those defined in commonly used dictionaries, will not be interpreted in an idealized or overly formal sense unless expressly so defined herein.

A term “part” or “module” used in the embodiments may mean software components or hardware components such as a field programmable gate array (FPGA), an application specific integrated circuit (ASIC). The “part” or “module” performs certain functions. However, the “part” or “module” is not meant to be limited to software or hardware. The “part” or “module” may be configured to be placed in an addressable storage medium or to restore one or more processors. Thus, for one example, the “part” or “module” may include components such as software components, object-oriented software components, class components, and task components, and may include processes, functions, attributes, procedures, subroutines, segments of a program code, drivers, firmware, microcode, circuits, data, databases, data structures, tables, arrays, and variables. Components and functions provided in the “part” or “module” may be combined with a smaller number of components and “parts” or “modules” or may be further divided into additional components and “parts” or “modules”.

Methods or algorithm steps described relative to some embodiments of the present disclosure may be directly implemented by hardware and software modules that are executed by a processor or may be directly implemented by a combination thereof.

The software module may be resident on a RAM, a flash memory, a ROM, an EPROM, an EEPROM, a resistor, a hard disk, a removable disk, a CD-ROM, or any other type of record medium known to those skilled in the art. An exemplary record medium is coupled to a processor and the processor can read information from the record medium and can record the information in a storage medium. In another way, the record medium may be integrally formed with the processor. The processor and the storage medium may reside in an application specific integrated circuit (ASIC). The ASIC may be resident within a user's terminal.

Hereinafter, a detailed description will be given as to the embodiments of the present disclosure with reference to the accompanying drawings in order for those skilled in the art to embody the present disclosure with ease. But the present disclosure is susceptible to variations and modifications and not limited to the embodiments described herein.

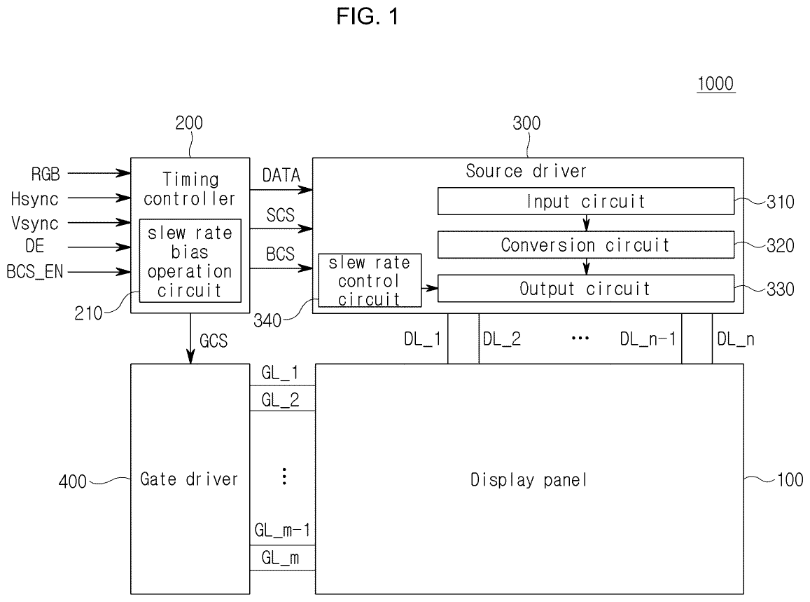

FIG. 1 illustrates a display device according to an example of the present disclosure.

Referring to FIG. 1, the display device 1000 may include a display panel 100, a timing controller 200, a source driver 300, and a gate driver 400.

According to an example, the display device 1000 may be a device capable of displaying an image or video. For example, the display device 1000 may be a device provided in a smartphone, a tablet personal computer, a mobile phone, a video phone, an e-book reader, a computer, a camera, or a wearable device, and capable of displaying images or video and may be provided in various devices which should display images or video.

According to an example, the display panel 100 may include a plurality of sub-pixels (PX) (not illustrated) disposed in columns and rows. The plurality of sub-pixels (PX) may be disposed in a lattice structure formed of m rows and n columns. (m and n are natural numbers)

For example, the display panel 100 may be implemented as at least one among an LCD (Liquid Crystal Display), an LED (Light Emitting Diode) display, an OLED (Organic LED) display, an AMOLED (Active-Matrix OLED) display, an ECD (Electrochromic Display), a DMD (Digital Mirror Device), an AMD (Actuated Mirror Device), a GLV (Grating Light Valve), a PDP (Plasma Display Panel), an ELD (Electro Luminescent Display), and a VFD (Vacuum Fluorescent Display), but is not limited thereto.

According to an example, the display panel 100 may include m gate lines (GL_1 to GL_m) which are arranged in m rows, and n source lines (SL_1 to SL_n) which are arranged in n columns. Sub-pixels may be disposed at intersections of the gate lines (GL_1 to GL_m) and the source lines (SL_1 to SL_n).

According to an example, the sub-pixels (PX) of the display panel 100 may be operated based on a unit of a gate line. For example, the sub-pixels disposed on one gate line is operated at a first interval and the sub-pixels disposed one another gate line is operated at a second interval following the first interval. At this instance, a unit time interval at which the sub-pixels (PX) are operated may be referred to one horizontal (1H) time.

According to an example, the sub-pixels (PX) may include a light emitting element configured to emit light and a light emitting drive circuit configured to drive the light emitting element. The light emitting driving circuit may be connected to one gate line and one data line, and the light emitting element may be connected between the light emitting drive circuit and a power voltage (for example, a ground voltage).

For example, the light emitting element may be a light emitting diode (LED), an organic LED (OLED), a quantum dot LED (QLED) or a Micro LED, but is not limited thereto.

According to an example, each of the sub-pixels (PX) may be one among a red element R outputting a red light, a green element G outputting a green light, a blue element B outputting a blue light, and a white element W outputting a white light, and the red element, the green element, the blue element, and the white element may be disposed in various ways in the display panel 100. The sub-pixels (PX) of the display panel 100 may be repeatedly disposed in the order of R, G, B, and G or B, G, R, and G or R, G, B, and W, etc. For example, the sub-pixels (PX) of the display panel 100 may be disposed according to an RGB stripe structure, an RGB pentile structure, and an RGBW arrangement structure, but is not limited thereto.

According to an example, the light element drive circuit may include a switching element connected to the gate lines (GL_1 to GL_m), for example, a thin film transistor (TFT). When the switching element is turned on because a gate-on signal is applied from the gate line (GL_1 to GL_m), the light emitting element drive circuit may provide a data signal (or a pixel signal) received from the data line (DL_1 to DL_n) connected to the light emitting drive circuit to the light emitting element. The light emitting element may output light corresponding to the image signal.

According to an example, the timing controller 200 may receive an image signal RGB from the external device, and generate image data DATA by processing the image signal RGB or converting the image signal RGB to be suitable for a structure of the display panel 100. The timing controller may generate the image data DATA distinguishable based on a unit of a gate line.

According to an example, the timing controller 200 may divide the image data DATA based on a unit of a line into the image data DATA based on a unit of a channel (hereinafter ‘channel unit’), and generate the image data DATA. The timing controller 200 may transmit the image data DATA to the source driver 300. The timing controller 200 may transmit the image data DATA based on a unit of a line to the source driver 300 at every horizontal time.

According to an example, the timing controller 200 may receive a plurality of control signals from an external host device. The control signals received from the host device may include a horizontal synchronization signal (Hsync), a vertical synchronization signal (Vsync), and a data enable signal (DE).

According to an example, based on received control signals, the timing controller 200 may generate a source driver control signal SCS for controlling the source driver 300, and a gate driver control signal GCS for controlling the gate driver 400. The timing controller 200 may generate a source driver control signal SCS and a gate driver control signal GCS based on the horizontal synchronization signal (Hsync).

According to an example, the timing controller 200 may control operation timings of the source driver 300 and the gate driver 400 based on the source driver control signal SCS and the gate driver control signal GCS.

According to an example, the timing controller 200 may transmit the source driver control signal SCS to the source driver 300, and the source driver 300 may output the data signal to the plurality of data lines (DL_1 to DL_n) based on the received source driver control signal SCS. The timing controller 200 may transmit the gate driver control signal GCS to the gate driver 400, and the gate driver 400 may output the gate signal to the plurality of gate lines (GL_1 to GL_m) based on the received source driver control signal SCS.

According to an example, the timing controller 200 may compare current data to previous data based on a channel unit of the source driver 300 and calculate data difference values based on a channel unit. The timing controller 200 may generate a bias control signal BCS matched with a preset threshold interval including the maximum value among the data difference values. The timing controller 200 may provide the bias control signal BCS to the source driver 300. The timing controller 200 may provide the bias control signal BCS to the source driver 300 independently, or by including the bias control signal BCS into the source control signal SCS. The source driver 300 may generate a bias current in response to the bias control signal BCS, and output the data signal by regulating a slew rate according to a magnitude of the bias current.

According to an example, the timing controller 200 may include a slew rate bias operation circuit 210 configured to output the bias control signal BCS. The slew rate bias operation circuit 210 may set a plurality of threshold intervals at which the data difference values between the previous data and the current data can be divided into intervals based on a channel unit of the source driver. The slew rate bias operation circuit 210 may set a bias control signal BCS matched with each of the plurality of threshold intervals. According to an example, the slew rate bias operation circuit 210 may generate the bias control signal BCS corresponding to the maximum value among the data difference values between the previous data and the current data at each of the plurality of threshold intervals.

According to an example, the slew rate bias operation circuit 210 may generate the bias control signal BCS configured to divide the data difference values into intervals to which the maximum value among the data difference values between the previous data and the current data can belong, to determine the bias current per interval, and to generate the bias current corresponding to the interval into which the maximum value among the data difference values between the previous data and the current data is included at each of the plurality of threshold intervals. At this instance, the slew rate bias operation circuit 210 may generate the bias control signal BCS which controls the source driver 300 to generate the bias current having a greater magnitude when the maximum value is included in a higher interval. The slew rate bias operation circuit 210 may generate the bias control signal BCS and transmit it to the source driver 300. The source driver 300 may generate a bias current by varying magnitudes based on the bias control signal BCS.

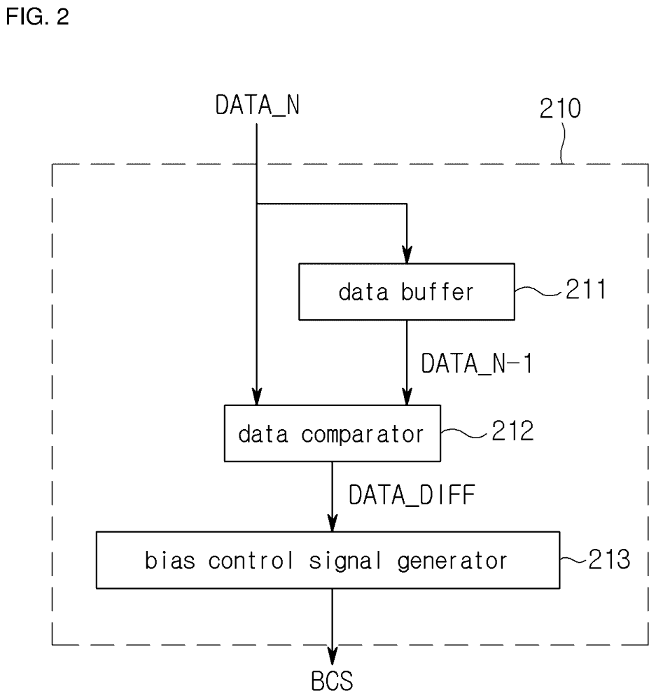

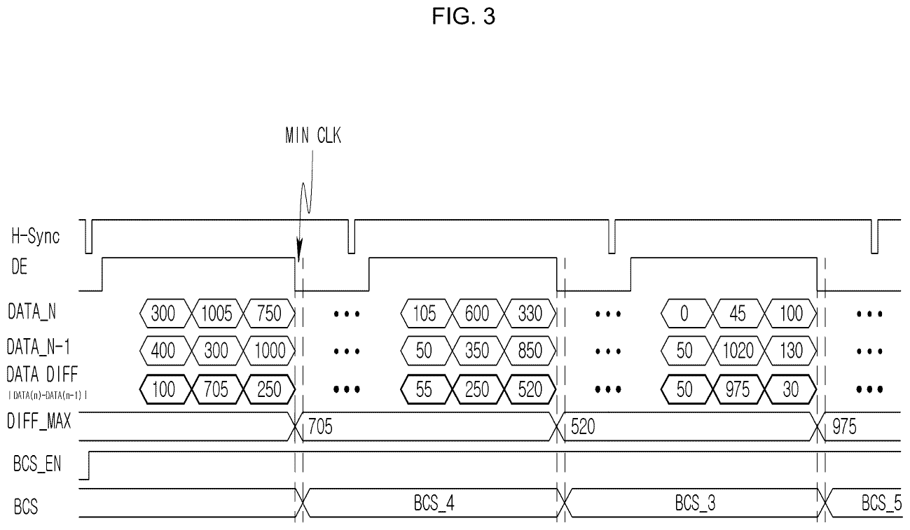

Referring to FIGS. 2 and 3, the configuration and operations of the slew rate bias operation circuit 210 will be described in more detail.

According to an example, the timing controller 200 may receive a bias control operation activating signal BCS_EN from a host device outside. The timing controller 200 may activate or inactivate the slew rate bias operation circuit 210 in response to the bias control operation activating signal BCS_EN. The timing controller 200 may output the normal bias control signal when the slew rate bias operation circuit 210 is inactivated. Here, the normal bias control signal may be a signal which controls the source driver 300 to use the maximum bias current. The timing controller 200 may output an active bias control signal which controls the source driver 300 to use a different bias current based on the data difference values between the previous data and the current data when the slew rate bias operating circuit 210 is activated. The source driver 300 may determine a magnitude of the bias current based on the active bias control signal, however, the magnitude of the bias current at this time may be less than or equal to a magnitude of the maximum bias current.

According to an example, the source driver 300 may output a data signal DS to the display panel 100 based on the image data DATA. The source driver 300 may generate data signals corresponding to the images displayed in the display panel 100, and transmit the generated data signals to the display panel 100. The data signals DS may be transmitted to each of the sub-pixels (PX). For example, the source driver 300 may provide the sub-pixels PX operating at the 1H time with data signals which should be displayed at the 1H time through the data lines (DL_1 to DL_n) for the 1H time.

According to an example, the source driver 300 may receive the image data DATA, and generate the data signals DS using gamma values corresponding to the image data DATA. Each of the data signals corresponds to the image data DATA, and is a signal for operating each of the sub-pixels PX. For example, the source driver 300 may output n data signals to the display panel 100.

According to an example, the source driver 300 may generate data signals based on the source control signal SCS. For example, the source control signal SCS may include a source start signal, a source shift clock signal, a source output enable signal, and the like.

According to an example, the source driver 300 may include an input circuit 310, a conversion circuit 320, an output circuit 330, and a slew rate control circuit 340.

The input circuit 310 may divide the image data DATA input based on a unit of a line from the timing controller 200 into the image data DATA based on a channel unit and output the image data DATA.

The conversion circuit 320 may generate gamma voltages corresponding to the image data DATA. For example, the conversion circuit 320 may generate the gamma voltages of the analogue voltage corresponding to the image data DATA having a digital value. The conversion circuit 320 may determine an analogue voltage corresponding to a data value of the image data DATA by interpolating reference gamma voltages which have been stored previously.

The conversion circuit 320 may generate gamma voltages corresponding to the image data divided based on a channel unit and provide the generated gamma voltages to the output circuit 330.

The output circuit 330 may receive the gamma voltages, and generate the data signals using the gamma voltages. The output circuit 330 may output the generated data signals to the display panel 100. The output circuit 330 may output the data signals through a plurality of channels connected to the data lines (DL_1 to DL_n).

The output circuit 330 may receive a bias current BC from the slew rate control circuit 340. The output circuit 330 may output the data signals to the display panel 100 by varying a slew rate based on a unit of the plurality of channels according to a magnitude of the bias current BC.

According to an example, the slew rate control circuit 340 may receive the bias control signal BCS. The slew rate control circuit 340 may generate the bias current BC which regulates a slew rate of the output circuit 330 based on the bias control signal BCS. The slew rate control circuit 340 may generate the bias current BC by varying a magnitude of the bias current BC according to the bias control signal BCS.

According to an example, the gate driver 400 may sequentially provide gate signals to the plurality of gate lines (GL_1 to GL_m) in response to the gate control signal (GCS). For example, the gate control signal (GCS) may include a gate start pulse instructing to start outputting a gate signal, a gate shift clock controlling a time point for outputting a gate-on signal, and the like.

According to an example, the gate driver 400 may generate a gate pulse in response to the gate shift clock when a gate start pulse is applied thereto, and sequentially provide gate signals to the gate lines (GL_1 to GL_m) using the gate pulse. Each of the gate signals is a signal for turning on sub-pixels (PX) connected to each of the gate lines (GL_1 to GL_m), and may be applied to the gate terminal of a transistor included in each of the pub-pixels (PX).

According to an example, the gate driver 400 may transmit a gate signal of a logic high level to the gate line to which the sub-pixels (PX) to be operated is connected, and transmit a gate signal of a logic low level to the gate line to which the sub-pixels (PX) not to be operated is connected. The gate signal of a logic high level may be referred to a gate-on signal, and the gate signal of a logic low level may be referred to a gate-off signal.

The timing controller 200, the source driver 300, and the gate driver 400 may be referred to as the display drive device for controlling the display panel 100. In addition, the timing controller 200, the source driver 300, and the gate driver 400 may be implemented as one integrated circuit, or each separate integrated circuit. Further, according to examples, the gate driver 400 may be mounted on the display panel 100.

FIG. 2 is a view illustrating the slew rate bias operation circuit according to an example of the present disclosure.

Referring to FIGS. 1 and 2, the slew rate bias operation circuit 210 may include a data buffer 211, a data comparator 212, a memory (not illustrated) and a bias control signal generator 213.

According to an example, the timing controller 200 may generate image data DATA using the image signal RGB received from the external device. The generated image data DATA may be output to the source driver 300. The timing controller 200 may generate image data DATA corresponding to the data signal DS to be output to each line of the display panel 100. For example, the timing controller 200 may generate current data DATA_N to be output to the pixel PX per horizontal time 1H and may output the current data DATA_N to the source driver 300. The current data DATA_N generated by the timing controller 200 may be stored in the data buffer 211. Referring to FIG. 1, the timing controller 200 may generate image data which can be divided based on a channel unit of the source driver 300.

According to an example, the data buffer 211 may receive and store the image data generated by the timing controller 200. The image data stored in the data buffer 211 may be the previous data DATA_N-1 output at the previous horizontal time in comparison with the current data DATA_N. The data buffer 211 may store the image data input at each horizontal time.

The data buffer 211 may store the image data corresponding to one line, and data may be updated at each horizontal time.

According to an example, the data comparator 212 may compare the current data DATA_N to the previous data DATA_N-1 based on a channel unit as illustrated in FIG. 2, and calculate data difference values DATA_DIFF per channel unit. The data comparator 212 may receive the current data DATA_N and obtain the previous data DATA_N-1 from the data buffer 211. The data comparator 212 may compare the current data DATA_N to the previous data DATA_N-1 based on a channel unit of the source driver 300, calculate the data difference values DATA_DIFF, and generate information on a maximum value (DIFF_MAX) among the data difference values. Here, the maximum value (DIFF_MAX) means a value having a maximum absolute value among the data difference values DATA_DIFF.

The data comparator 212 may provide the bias control signal generator 213 with the generated information on the maximum value (DIFF_MAX).

According to an example, the memory (not illustrated) may store data for the bias control signal BCS.

The memory may store a plurality of threshold intervals set such that the data difference values between the previous data DATA_N-1 and the current data DATA_N can be divided based on a channel unit of the source driver 300. The memory may store the bias control signal BCS set to be matched with each of the plurality of threshold intervals. For example, in case of a higher interval of the plurality of threshold intervals, the bias control signal BCS which controls the source driver to generate a greater bias current BC may be stored in correspondence with the threshold interval.

The memory may include at least one among a non-volatile memory and a volatile memory. The bias control signal generator 213 may read set values stored in the memory and generate and output the bias control signals BCS using the read set values.

According to an example, the bias control signal generator 213 may generate the bias control signal BCS matched with one threshold interval which includes the maximum value among the preset plurality of threshold intervals.

According to an example, the bias control signal generator 213 may receive the information on the maximum value (DIFF_MAX) from the data comparator 212. The bias control signal generator 213 may generate the bias control signal BCS matched with one threshold interval which includes the maximum value among the preset plurality of threshold intervals. The bias control signal generator 213 may generate the bias control signal BCS which controls the source driver 300 to generate a greater bias current at the higher interval among the plurality of threshold intervals. The bias control signal generator 213 may provide the source driver 300 with the bias control signal BCS. The source driver 300 may use the bias current by varying a magnitude of the bias current according to the bias control signal BCS.

Table 1 represents an example of the threshold intervals which can be used by the bias control signal generator 213. In Table 1, the maximum and minimum values at each interval are set randomly, and the values in Table 1 are just an example and may differ.

TABLE 1

| Threshold interval | DIFF_MAX | BCS |
|---|---|---|
| 5 | DIFF_MAX ≥ 900 | BCS_5 |
| 4 | 900 > DIFF_MAX ≥ 700 | BCS_4 |
| 3 | 700 > DIFF_MAX ≥ 500 | BCS_3 |
| 2 | 500 > DIFF_MAX ≥ 300 | BCS_2 |
| 1 | 300 > DIFF_MAX ≥ 100 | BCS_1 |
| 0 | 100 > DIFF_MAX | BCS_0 |

Referring to Table 1, when the interval which includes the maximum value (DIFF_MAX) among the data difference values between the previous data DATA_N-1 and the current data DATA_N is equal to or greater than 900, the bias control signal BCS may be BCS_5. As another example, when the maximum value (DIFF_MAX) is equal to or greater than 700 and smaller than 900, the bias control signal BCS may be BCS_4. When the maximum value (DIFF_MAX) is smaller than 100, the bias control signal BCS may be BCS_0. Here, the bias control signals BCS BCS_0 to BCS_5 may be the bias control signals BCS representing a magnitude of the bias current to be generated by the source driver 300. According to an example, the BCS_5 may represent the greatest bias current and the BCS_0 may represent the smallest bias current.

FIG. 3 illustrates a timing diagram for describing an operation of a slew rate bias operation circuit according to an example of the present disclosure.

Referring to FIGS. 1 to 3, according to an example, the timing controller 200 may generate image data DATA which can be divided based on a unit of a gate line in response to the horizontal synchronization signal (Hsync), and a data enable signal (DE). In synchronization with the horizontal synchronization signal (Hsync), the timing controller 200 may provide the image data DATA to the source driver 300. In addition, the timing controller 200 may provide the corresponding image data DATA to the slew rate bias operation circuit 210, as well.

According to an example, the slew rate bias operation circuit 210 may generate the data difference value (DATA_DIFF) between the image data DATA generated in synchronization with the previous data DATA_N-1 stored in the data buffer 211 (the image data DATA generated in synchronization with the previous horizontal synchronization signal (Hsync)) and the image data DATA generated in synchronization with the current data (DATA_N) provided by the timing controller 200 (the image data DATA generated in synchronization with the current horizontal synchronization signal (Hsync)), based on a unit of the channel (channel unit) DL_1 to DL_n of the source driver 300. In addition, the slew rate bias operation circuit 210 may generate the maximum value (DIFF_MAX) among the data difference values (DATA_DIFF) between the current data DATA_N and the previous data DATA_N-1.

Referring to an example of FIG. 3, in a first horizontal synchronization signal, the data difference values (DATA_DIFF) between the current data DATA_N and the previous data DATA_N-1 may be 100, 705, and 250, etc. In addition, the maximum value (DIFF_MAX) among the data difference values (DATA_DIFF) may be 705. In a second horizontal synchronization signal, the data difference values (DATA_DIFF) between the current data DATA_N and the previous data DATA_N-1 may be 55, 250, and 520, etc. In addition, the maximum value (DIFF_MAX) among the data difference values (DATA_DIFF) may be 520.

After determining the maximum value (DIFF_MAX) among the data difference values (DATA_DIFF), the slew rate bias operation circuit 210 may determine one threshold interval which includes the maximum value (DIFF_MAX) among the preset plurality of threshold intervals as Table 1.

Referring to examples of Table 1 and FIG. 3, the maximum value (DIFF_MAX) at a first horizontal synchronization period is 705, and this value may belong to a threshold interval 4. Therefore, the slew rate bias operation circuit 210 may output BCS_4 as the bias control signal, as illustrated in FIG. 3. In addition, at a second horizontal synchronization period, the maximum value (DIFF_MAX) is 520, and this value may belong to a threshold interval 3. Therefore, the slew rate bias operation circuit 210 may output BCS_3 as the bias control signal, as illustrated in FIG. 3.

Referring to FIG. 3, the slew rate bias operation circuit 210 may receive data on all channels within the horizontal synchronization period when the data enable signal DE is an off signal, and when the data difference values (DATA_DIFF) and the maximum value (DIFF_MAX) are determined, the slew rate bias operation circuit 210 may generate the bias control signal BCS after a delay by as much as the minimum clock (MIN CLK).

The source driver 300 may generate the bias current by varying a magnitude of the bias current according to received bias control signals (BCS_0 to BCS_5) and regulate the slew rate at which the image data DATA is output.

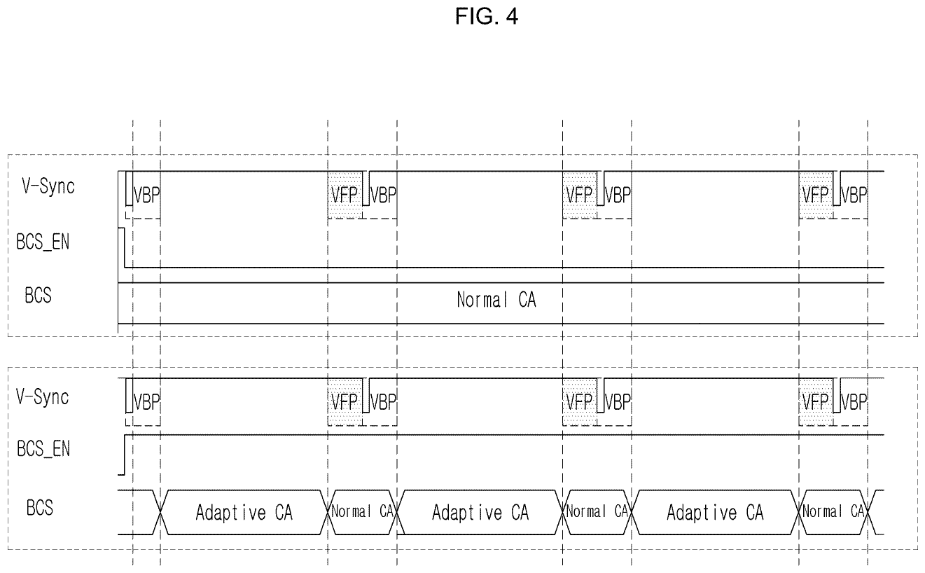

FIG. 4 illustrates a timing diagram for describing an operation of the timing controller according to an example of the present disclosure.

Referring to FIGS. 1 and 4, according to an example, the timing controller 200 may receive a bias control operation activating signal BCS_EN from an external host device. The timing controller 200 may output the bias control signal BCS in response to the bias control operation activating signal BCS_EN. The bias control signal BCS may be output in a manner of being divided into the normal bias control signal and the active bias control signal. Here, the normal bias control signal may be a signal which controls the source driver 300 to output the maximum bias current. The active bias control signal may be a signal which controls the source driver 300 to output a bias current having a value equal to or smaller than a magnitude of the maximum bias current while varying a magnitude of the current.

According to an example, when the bias control operation activating signal BCS_EN is an on signal, the timing controller 200 may output the normal bias control signal at a porch interval and output the active bias control signal at an active interval. A vertical synchronization interval at which one frame can be output may be divided into a vertical front porch VFP interval, an active interval, and a vertical back porch VBP interval. When the bias control operation activating signal BCS_EN is an on signal, the timing controller 200 may provide the normal bias control signal to the source driver at the front porch VFP interval and the back porch VBP interval so that the source driver 300 can output the maximum bias current having the highest slew rate, and provide the active bias control signal to the source driver 300 at the active interval based on the data difference values between the current data and the previous data. At the active interval, the source driver 300 may output the bias current having a value equal to or smaller than a magnitude of the maximum bias current by varying a magnitude of the current based on the bias control signal, and may regulate a slew rate of the output circuit 330 included in the source driver 300.

According to an example, when the bias control operation activating signal BCS_EN is an off signal, in response thereto, the timing controller 200 may output the normal bias control signal at all interval. Even if there is a difference between the previous data and the current data at the active interval, the timing controller 200 may provide the normal bias control signal to the source driver 300 so that the source driver 300 can use the maximum bias current at all intervals.

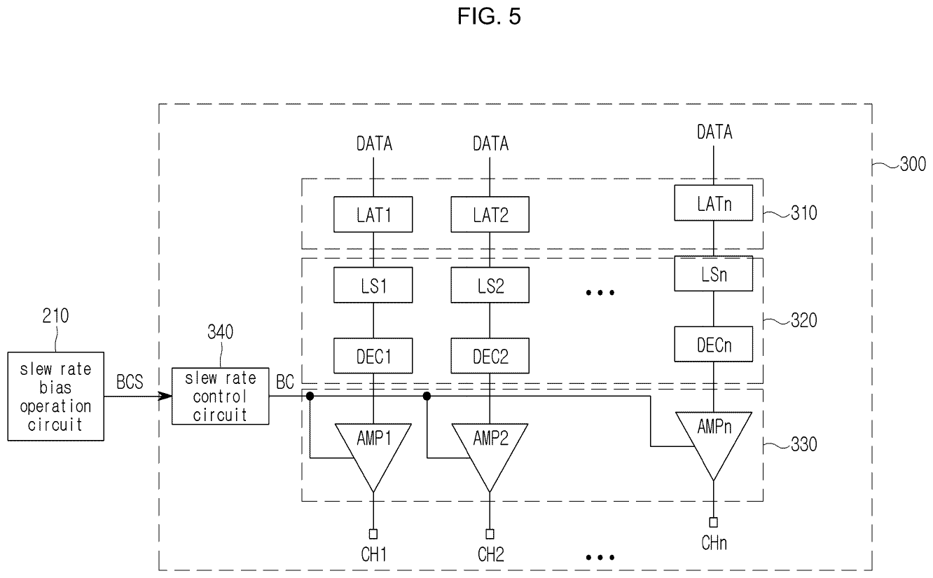

FIG. 5 illustrates the source driver according to an example of the present disclosure.

Referring to FIGS. 1 to 5, according to an example, the source driver 300 may include the input circuit 310, the conversion circuit 320, the output circuit 330, and the slew rate control circuit 340. The source driver 300 may include a plurality of drive circuits, and may divide the plurality of drive circuits into the input circuit 310, the conversion circuit 320, and the output circuit 330 according to functions of the components of the plurality of drive circuits.

Meanwhile, a source driver of the conventional display drive device includes both a slew rate operation circuit and a slew rate control circuit. The display drive device configured as above additionally needs a process in which the source driver receives the current data and the previous data from the timing controller for data processing, therefore, an overall size of the display drive device may increase because of increased data lines between the timing controller and the source driver.

Conversely, each of the slew rate bias operation circuit 210 and the slew rate control circuit 340 of the display drive device according to an example of the present disclosure may be provided separately in the source driver 300. Unlike the conventional display drive device, when the slew rate bias operation circuit 210 is included in the timing controller 200 rather than the source driver 300, because the timing controller may perform data processing without a need for the source driver 300 to receive the current data and the previous data from the timing controller 200, and may provide only the bias control signal BCS according to the data processing to the source driver 300, a size of the display drive device can be reduced.

According to an example, the input circuit 310 may divide the image data DATA input based on a unit of a line from the timing controller 200 into the image data DATA based on a channel unit of the source driver 300, and output the image data.

The input circuit 310 may receive image data DATA transmitted from the timing controller 200, latch the image data DATA, and output the latched image data DATA to the conversion circuit 320.

According to an example, after receiving the image data DATA expressed with continuous bits, a latch (LAT1 to LATn) corresponding to each channel provided in the input circuit 310 may latch some of the image data DATA corresponding to the respective channel and output the latched image data DATA to the conversion circuit 320. For example, after receiving the image data DATA of 8N bits, the input circuit 310 may latch 8 bits corresponding to each channel of the image data DATA of 8N bits and output the latched 8 bits to the conversion circuit 320.

According to an example, the conversion circuit 320 may generate analogue voltages using the image data DATA output from the input circuit 310. The conversion circuit 320 may generate gamma voltages which are analogue voltages corresponding to a data value of the image data DATA.

The conversion circuit 320 may determine the analogue voltages corresponding to a data value of the image data DATA by using prestored reference gamma voltages. The conversion circuit 320 may determine the analogue voltage corresponding to a data value of the image data DATA by interpolating the prestored reference gamma voltages. The conversion circuit 320 may provide the output circuit 330 with the generated analogue voltage.

For example, the conversion circuit 320 may include a level shifter (LS1 to LSn) configured to shift a level of the image data DATA provided from the input circuit 310, and a decoder (DEC1 to DECn) configured to generate an analogue voltage by using the image data DATA transmitted from (and of which the level is shifted) the level shifter (LS1 to LSn).

According to an example, the output circuit 330 may receive analogue voltages, and output the analogue voltages to the display panel 100 after amplifying the analogue voltages using an amplifier (AMP1 to AMPn). Here, the amplifier may be provided per channel. The output circuit 330 may receive the bias current BC from the slew rate control circuit 340. The output circuit 330 may output the analogue signal of which the slew rate is varied per channel according to a magnitude of the received bias current BC.

According to an example, the slew rate control circuit 340 may receive the bias control signal BCS from the slew rate bias operation circuit 210. The slew rate control circuit 340 may generate the bias current BC having a magnitude determined according to the bias control signal. The bias current BC output from the slew rate control circuit 340 may be provided to the output circuit 330. The output circuit 330 may output an analogue signal, of which the slew rate may vary according to the bias current having a different magnitude per horizontal time.

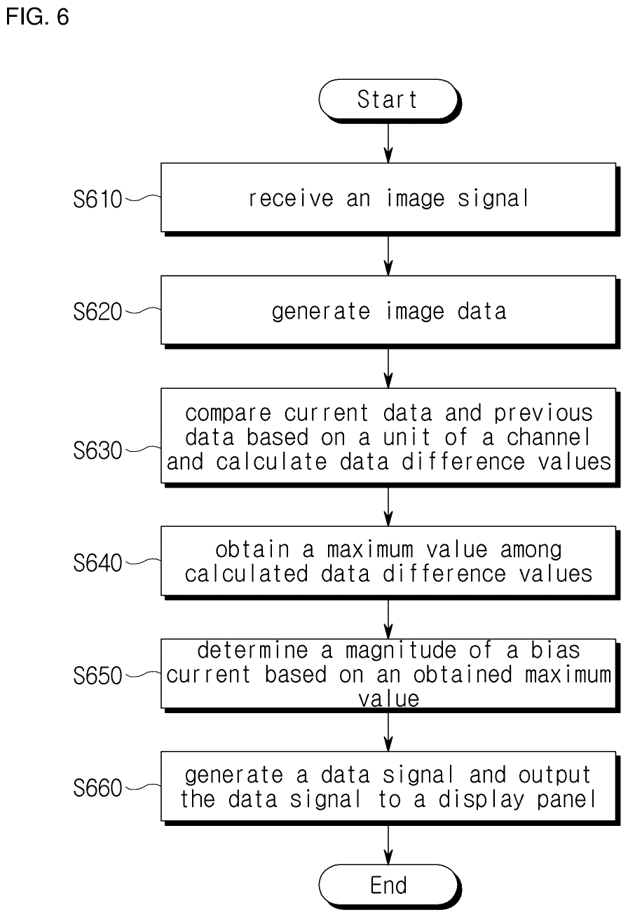

FIG. 6 illustrates an operation method of a display drive device according to an example of the present disclosure.

Referring to FIGS. 1 to 6, in an operation S610, the timing controller 200 of the display drive device may receive the image signal RGB from the external device. In addition, the display drive device may receive the control signals for controlling frames together with the image signal RGB.

In an operation S620, the timing controller 200 of the display drive device may generate the image data DATA based on the received image signal RGB. The image data DATA is generated according to a frame structure generated by the timing controller 200, and may be provided to the source driver 300.

In an operation S630, the slew rate bias operation circuit 210 of the timing controller 200 of the display drive device may compare the current data to the previous data based on a channel unit of the source driver 300 and calculate the data difference values.

In an operation S640, the slew rate bias operation circuit 210 of the timing controller 200 of the display drive device may obtain the maximum value among the calculated data difference values.

In an operation S650, the slew rate bias operation circuit 210 of the timing controller 200 of the display drive device may determine a magnitude of the bias current to be used by the source driver 300 based on the obtained maximum value. The slew rate bias operation circuit 210 of the timing controller 200 of the display drive device may generate and transmit the bias control signal representing the determined magnitude of the bias current to the source driver 300, and the source driver 300 may generate and use the bias current based on the received bias control signal.

In an operation S660, the source driver 300 of the display drive device may generate the data signal based on the current data and a control signal related to a magnitude of the bias current received from the timing controller 200, and output the data signal to the display panel 100.

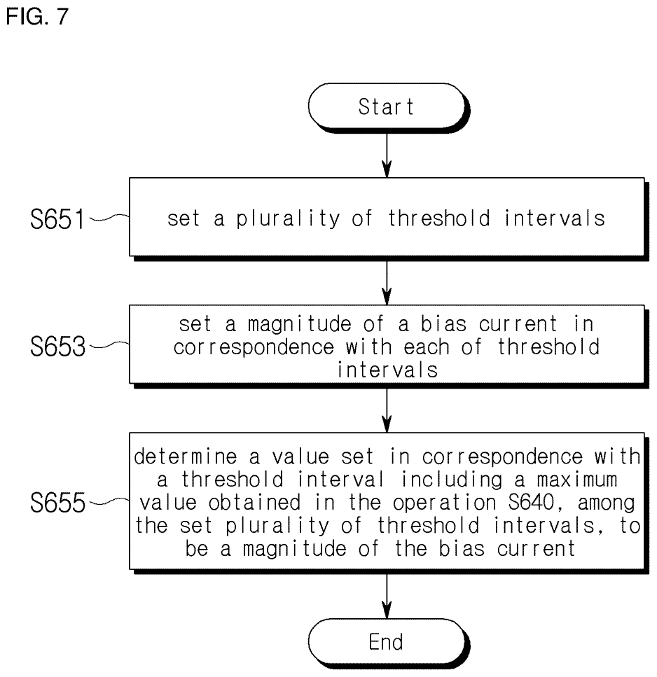

FIG. 7 illustrates a method for determining a magnitude of the bias current according to an example of the present disclosure. FIG. 7 may be a description of an example of the operation S650 of FIG. 6.

Referring to FIG. 7, the display drive device, in an operation S651, may set a plurality of threshold intervals. The plurality of threshold intervals may be set randomly. Table 1 shows an example of setting the plurality of threshold intervals.

The display drive device, in an operation S653, may set a magnitude of the bias current in correspondence with each of the plurality of threshold intervals. At this instance, when the data difference value calculated in the operation S630 belongs to a higher interval among the plurality of threshold intervals, a magnitude of the set bias current may increase.

Here, the setting according to the operations S651 and S653 is performed only once at the beginning, and the setting may not be used thereafter, or the setting may be performed only when changing the threshold intervals or when there is a need to change a magnitude of the bias current set in correspondence with each threshold interval.

In an operation S655, the display drive device may determine a value set in correspondence with the threshold interval including the maximum value obtained in the operation S640, among the set plurality of threshold intervals, to be a magnitude of the bias current.

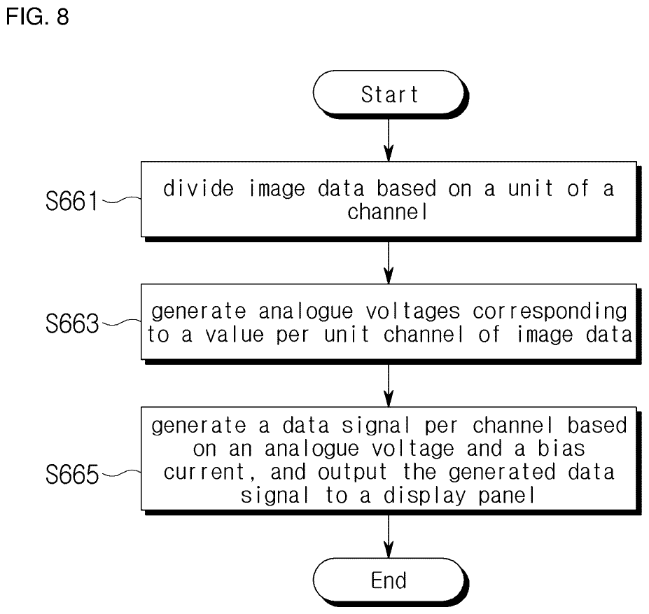

FIG. 8 illustrates a method for generating a data signal in a source driver and outputting the data signal to a display panel according to an example of the present disclosure. FIG. 8 may be a description of an example of the operation S660 of FIG. 6.

Referring to FIG. 8, in an operation S661, the source driver 300 of the display drive device may divide the image data DATA received from the timing controller 200 based on a channel unit. According to an example, each channel unit may include 8-bit data.

In an operation S663, the source driver 300 of the display drive device may generate analogue voltages corresponding to a value per channel unit. Here, the analogue voltage may be a gamma voltage obtained in correspondence with the 8-bit digital data.

In an operation S665, the source driver 300 of the display drive device may generate a data signal per channel based on an analogue voltage per channel and the bias current, and may output the generated data signal to the display panel.

As described above, the present disclosure can regulate the slew rate by varying a magnitude of the bias current to be provided to the source amplifier provided in the source driver 300 and configured to output a data signal to the display panel and can improve heating characteristics by reducing power consumption.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A display drive device configured to drive a display panel, comprising:
a timing controller configured to:
compare current data to previous data based on a channel unit in horizontal time,
calculate data difference values, and
output a bias control signal determined based on a maximum value among the calculated data difference values; and
a source driver configured to generate a bias current based on the bias control signal and based on the channel unit,
wherein the source driver comprises an output circuit configured to output a data signal to a plurality of channels based on the bias current generated based on the channel unit.

2. The display drive device of claim 1, wherein the timing controller comprises a slew rate bias operation circuit configured to:
divide the data difference values into intervals based on the channel unit of the source driver and set a plurality of threshold intervals, and
output the bias control signal matched with the plurality of threshold intervals including the maximum value.

3. The display drive device of claim 2, wherein the slew rate bias operation circuit is configured to set the bias control signal such that the bias current having a greater magnitude is generated when the maximum value is included in a higher threshold interval among the plurality of threshold intervals.

4. The display drive device of claim 2, wherein the slew rate bias operation circuit comprises:
a data buffer storing the previous data;
a data comparator configured to calculate a data difference value by comparing the current data to the previous data stored in the data buffer based on the channel unit; and
a bias control signal generator configured to:
select a threshold interval comprising the maximum value among the plurality of threshold intervals, and
generate a bias control signal matched with the selected threshold interval based on the channel unit.

5. The display drive device of claim 1, wherein the source driver further comprises:
an input circuit configured to divide image data input based on the channel unit into image data based on the channel unit of the source driver and output the image data;
a conversion circuit configured to output analogue voltages corresponding to the image data divided based on the channel unit; and
a slew rate control circuit configured to generate the bias current to regulate a slew rate of the source driver based on the bias control signal.

6. The display drive device of claim 1, wherein the output circuit includes:
a plurality of source amplifiers provided in each channel of the source driver and configured to output the data signal based on a magnitude of the bias current.

7. The display drive device of claim 1, wherein the timing controller is configured to output a normal bias control signal or an active bias control signal based on a bias control operation activating signal,
wherein the normal bias control signal is a signal that controls the source driver to use a bias current having a maximum magnitude, and
wherein the active bias control signal is a signal that controls the source driver to use a bias current having a value less than or equal to the maximum magnitude.

8. The display drive device of claim 7, wherein the timing controller is configured to output the normal bias control signal only when the bias control operation activating signal is an off signal, and
wherein the timing controller is configured to output the normal bias control signal at a porch interval of a frame and output the active bias control signal at an active interval except the porch interval when the bias control operation activating signal is an on signal.

9. A method for operating a display drive device configured to drive a display panel, the method comprising:
generating image data to be displayed on the display panel;
allowing a timing controller to compare current data to previous data based on a channel unit of a source driver in horizontal time and calculate data difference values;
obtaining a maximum value among the calculated data difference values;
outputting a bias control signal based on the maximum value; and
outputting a bias current to be provided to an output circuit of the source driver according to the bias control signal.

10. The method for operating a display drive device of claim 9, wherein the obtaining of the maximum value among the calculated data difference values further comprises:
dividing the data difference values into intervals based on the obtained maximum value, and setting a plurality of threshold intervals; and
setting a magnitude of the bias current corresponding to each of the plurality of threshold intervals.

11. The method for operating a display drive device of claim 10, wherein the setting of the magnitude of the bias current corresponding to each of the plurality of threshold intervals further comprises:
setting the magnitude of the bias current to be greater when the maximum value is high in each of the plurality of threshold intervals.

12. The method for operating a display drive device of claim 9, wherein the outputting of the bias current to be provided to the output circuit of the source driver according to the bias control signal further comprises:
outputting a data signal to the display panel based on a magnitude of the bias current generated based on the channel unit.

13. A display drive device configured to drive a display panel, comprising:
a timing controller configured to:
compare current data to previous data based on a normal bias control signal or based on a channel unit,
calculate data difference values, and
output an active bias control signal determined based on a maximum value among the calculated data difference values; and
a slew rate control circuit configured to receive the normal bias control signal or the active bias control signal and control an output circuit of a source driver.

14. The display drive device of claim 13, wherein the timing controller comprises:
a slew rate bias operation circuit configured to:
divide the data difference values into intervals based on the channel unit of the source driver, and
set a plurality of threshold intervals and output a bias control signal matched with the plurality of threshold intervals including the maximum value.

15. The display drive device of claim 14, wherein the slew rate bias operation circuit is configured to set the active bias control signal such that a bias current having a greater magnitude is generated when the maximum value is included in a higher threshold interval among the plurality of threshold intervals.

16. The display drive device of claim 14, wherein the slew rate bias operation circuit comprises:
a data buffer storing the previous data;
a data comparator configured to compare the current data to the previous data stored in the data buffer based on the channel unit to calculate a data difference value; and
a bias control signal generator configured to select a threshold interval including the maximum value among the plurality of threshold intervals and generate the bias control signal matched with the selected threshold interval based on the channel unit.

17. The display drive device of claim 13, wherein the source driver comprises:
an input circuit configured to divide image data input based on the channel unit into image data based on the channel unit of the source driver and output the image data;
a conversion circuit configured to output analogue voltages corresponding to the image data divided based on the channel unit; and
an output circuit configured to output a data signal to the display panel based on the analogue voltages and a bias current.

18. The display drive device of claim 17, wherein the output circuit comprises:
a plurality of source amplifiers provided in each channel of the source driver and configured to output the data signal based on a magnitude of the bias current.

19. The display drive device of claim 13, wherein the timing controller is configured to output the normal bias control signal or the active bias control signal based on a bias control operation activating signal,
wherein the normal bias control signal is a signal that controls the source driver to use a bias current having a maximum magnitude, and
wherein the active bias control signal is a signal that controls the source driver to use a bias current having a value less than or equal to the maximum magnitude.

20. The display drive device of claim 19, wherein the timing controller is configured to output the normal bias control signal only when the bias control operation activating signal is an off signal, and
wherein the timing controller is configured to output the normal bias control signal at a porch interval of a frame and output the active bias control signal at an active interval except the porch interval when the bias control operation activating signal is an on signal.
